(19) United States
(12) Patent Application Publication
(10) Pub. No.: US 2015/0355429 A1
(43) Pub. Date: Dec. 10, 2015

(54) ASSEMBLY FOR DISTRIBUTING HYBRID CABLE AND TRANSITIONING FROM TRUNK CABLE TO JUMPER CABLE

(71) Applicant: CommScope Technologies LLC, Hickory, NC (US)

(72) Inventors: Henry Villegas, Orland Park, IL (US); James P. Nolan, Yorkville, IL (US); Nahid Islam, Westmont, IL (US)

(21) Appl. No.: 14/689,628

(22) Filed: Apr. 17, 2015

Related U.S. Application Data
(60) Provisional application No. 62/007,486, filed on Jun. 4, 2014.
(60) Provisional application No. 62/097,455, filed on Dec. 29, 2014.

(51) Int. Cl. G02B 6/44; H01B 9/00

(52) U.S. Cl. CPC G02B 6/4472; G02B 6/4416; H01B 9/005

(57) ABSTRACT

An assembly includes: a hybrid power/fiber optic cable comprising pluralities of power conductors and optical fibers, the plurality of power conductors and the plurality of optical fibers contained within a common jacket; a first breakout canister; and a second breakout canister. The hybrid power/fiber optic cable enters the first breakout canister and a plurality of power cords exit the first breakout canister, the power conductors of the hybrid power/fiber optic cable and the power cords being electrically connected within the first breakout canister, a respective one of a plurality of first conduits protecting each of the plurality of power cords. The plurality of optical fibers enters the first breakout canister and exits the first breakout canister, the exiting plurality of optical fibers being protected by a second conduit attached to the first breakout canister. The plurality of optical fibers enters the second breakout canister and exits the second breakout canister.

### RELATED APPLICATIONS

The present application claims priority from and the benefit of U.S. Provisional Patent Application No. 62/007,486, filed Jun. 4, 2014, and U.S. Provisional Patent Application No. 62/097,455, filed Dec. 29, 2014, the disclosure of each of which is hereby incorporated herein in its entirety.

### FIELD OF THE INVENTION

The present invention relates generally to electronic equipment, and more particularly to transition devices for distributing power and/or signals from cables.

### BACKGROUND

In the design of a hybrid power/fiber cable assembly it is often required that the separated cables be protected from certain birds, in particular cockatoos, that tend to damage the cables through unwanted pecking. To “bird-proof” the cables, a protective conduit is typically used. The protective conduit is generally greater than 19 mm in diameter to prevent the birds from pecking at and damaging the cables.

For a hybrid power/fiber optic cable used at a base station or antenna employing a 9 remote radio unit (RRU) configuration, which has 9 power cable pairs and 36 fiber cables, the breakout area (in which the individual power cable pairs and optical fibers of a hybrid power/fiber cable are separated from each other for individual connection) can become very large and difficult to mount on a tower. Use of an enclosure to achieve breakout can create unacceptable levels of wind loading on the tower and extended assembly times.

### SUMMARY

As a first aspect, embodiments of the invention are directed to an assembly, comprising: a hybrid power/fiber optic cable comprising a plurality of power conductors and a plurality of optical fibers, the plurality of power conductors and the plurality of optical fibers contained within a common jacket; a first breakout canister; and a second breakout canister. The hybrid power/fiber optic cable enters the first breakout canister and a plurality of power cords exit the first breakout canister, the power conductors of the hybrid power/fiber optic cable and the power cords being electrically connected within the first breakout canister, a respective one of a plurality of first conduits attached to the first breakout canister and protecting each of the plurality of power cords. The plurality of optical fibers enters the first breakout canister and exits the first breakout canister, the exiting plurality of optical fibers being protected by a second conduit attached to the first breakout canister. The plurality of optical fibers enters the second breakout canister and exits the second breakout canister, the exiting plurality of optical fibers being divided into subgroups, each subgroup being protected by a respective one of a plurality of third conduits attached to the second breakout canister.

As a second aspect, embodiments of the invention are directed to an assembly, comprising: a hybrid power/fiber optic cable comprising a plurality of power conductors and a plurality of optical fibers, the plurality of power conductors and the plurality of optical fibers contained within a common jacket; a first breakout canister; and a second breakout canister. The hybrid power/fiber optic cable enters the first breakout canister and a plurality of power cords exit the first breakout canister, the power conductors of the hybrid power/fiber optic cable and the power cords being electrically within the first breakout canister, a respective one of a plurality of first conduits attached to the first breakout canister and protecting each of the plurality of power cords. The plurality of optical fibers enters the first breakout canister and exits the first breakout canister, the exiting plurality of optical fibers being protected by a second conduit attached to the first breakout canister. The plurality of optical fibers enters the second breakout canister and exits the second breakout canister, the exiting plurality of optical fibers being divided into subgroups, each subgroup being protected by a respective one of a plurality of third conduits attached to the second breakout canister. Each of the first, second and third plurality of conduits is at least 19 mm in diameter.

As a third aspect, embodiments of the invention are directed to an assembly, comprising: a hybrid power/fiber optic cable comprising a plurality of power conductors and a plurality of optical fibers, the plurality of power conductors and the plurality of optical fibers contained within a common jacket; a first breakout canister; and a second breakout canister. The hybrid power/fiber optic cable enters the first breakout canister and a plurality of power cords exit the first breakout canister, the power conductors of the hybrid power/fiber optic cable and the power cords being electrically connected within the first breakout canister, a respective one of a plurality of first conduits attached to the first breakout canister and protecting each of the plurality of power cords. The plurality of optical fibers enters the first breakout canister and exits the first breakout canister, the exiting plurality of optical fibers being protected by a second conduit attached to the first breakout canister. The plurality of optical fibers enters the second breakout canister and exits the second breakout canister, the exiting plurality of optical fibers being divided into subgroups, each subgroup being protected by a respective one of a plurality of third conduits attached to the second breakout canister. The assembly is connected with a 9 remote radio head (RRU) configuration.

### BRIEF DESCRIPTION OF THE FIGURES

FIG. 1 is a front perspective view of an assembly for distributing optical fibers and splicing the power conductors of a hybrid power/fiber optic cable to power jumper cables according to embodiments of the invention.

FIG. 2 is a section view of the body of the first breakout canister of the assembly of FIG. 1.

FIG. 3 is a section view of the cover of the first breakout canister of the assembly of FIG. 1.

FIG. 4 is a section view of the body of the second breakout canister of the assembly of FIG. 1.

FIG. 5 is a section view of the cover of the second breakout canister of the assembly of FIG. 1.

FIG. 6 is an exploded perspective view of an alternative embodiment of a first breakout canister for the assembly of FIG. 1.

FIG. 7 is a section view of the assembled canister of FIG. 6.

FIG. 8 is an exploded view of the cover and sockets of the canister of FIG. 6.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

As discussed above, in the design of a hybrid power/fiber cable assembly it is often required that the cables be “bird-proofed” with a protective conduit greater than 19 mm in diameter. Breakout enclosures for 9 RRU configurations are often so large that they create unacceptable levels of wind loading on the tower and extended assembly times.

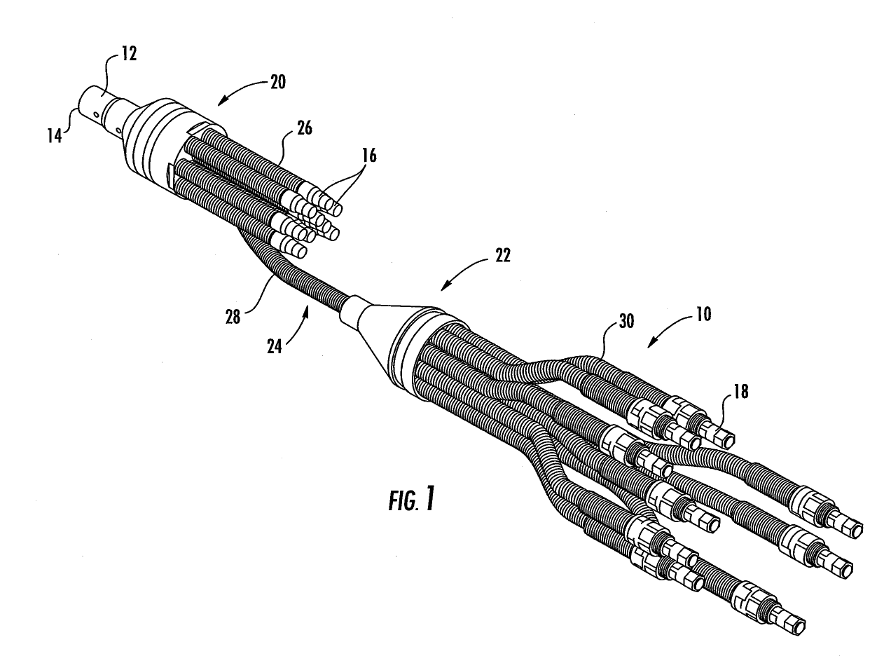

An assembly shown in FIG. 1 and designated broadly at 10 can address these concerns. The assembly 10 includes a hybrid power/fiber optic cable 12 with a jacket 14 that includes nine power cables and 36 optical fibers. The hybrid/fiber optic cable 12 enters a first breakout canister 20, wherein the power cables are electrically connected (i.e., spliced into or passed through) to nine power cable pairs 16 and the optical fibers are permitted to pass through as a single unit 24. The optical fibers then travel to a second breakout canister 22, wherein the optical fibers are separated into nine optical fiber subgroups 18. Notably, the power cable pairs 16 are each protected with a respective conduit 26, the optical fibers passing from the first breakout canister 20 to the second breakout canister 22 are protected by a conduit 28, and the optical fiber subgroups 18 are each protected with a respective conduit 30. These components are discussed in greater detail below.

The hybrid power/fiber optic cable 12 can be any conventional hybrid power/fiber optic cable, and may have more or fewer power cables and/or optical fibers. An exemplary hybrid power/fiber optic cable is the HTC-24SM-1206-618-APV cable, available from CommScope, Inc. (Hickory, N.C.).

The conduits 26, 28, 30 are formed of a material such as nylon that is sufficiently hardy to resist damage from birds. The conduits 26, 28, 30 in the illustrated embodiment are 21 mm in diameter, but may be sized differently (typically they are at least 19 mm in diameter).

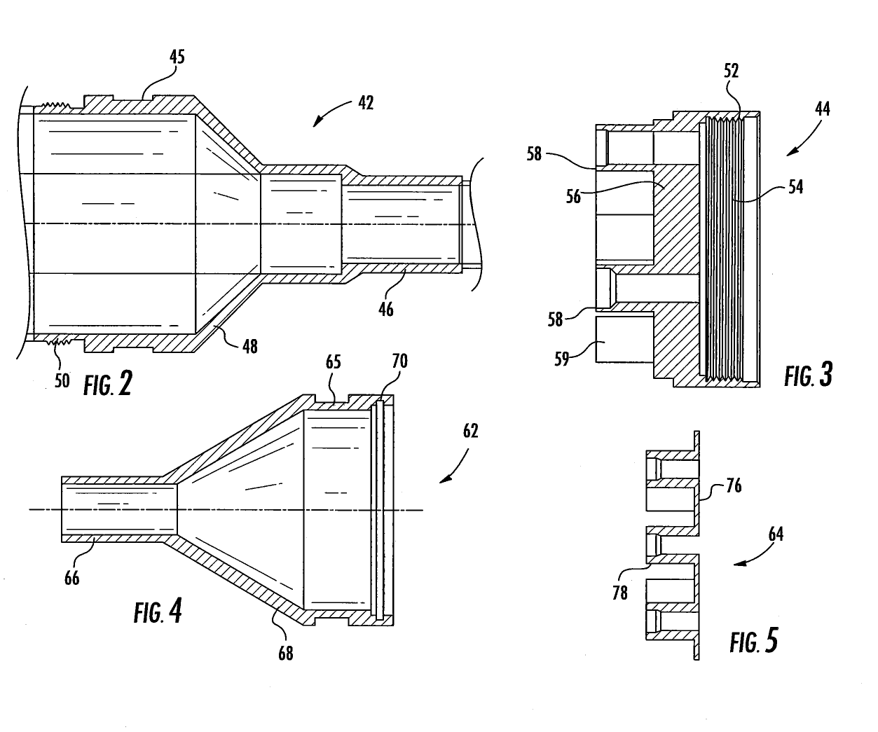

Referring now to FIGS. 2 and 3, the first breakout canister 20 comprises a body 42 and a cover 44. The body 42 includes a hollow stem 46 at one end and a cylindrical receptacle 48 with external threads 50 at the opposite end. The body 42 also includes a circumferential groove 45 on its outer surface that can receive a band clamp for mounting. The cover 44 has a cylindrical wall 52 with internal threads 54, a plate 56 at one end of the wall 52, and sockets 58 that extend from the plate 56. Conduits 26 fit over the sockets 58 and extend therefrom (FIG. 1).

As can be seen in FIG. 1, the hybrid power/fiber optic cable 12 enters the body 42 through the stem 46. The power cables are broken out from the hybrid power/fiber optic cable 12 and spliced with the nine power cable pairs 16 (typically through a crimping operation). The power cable pairs 16 are routed through respective sockets 58 in the cover 44 (i.e., on the side opposite the stem 46), wherein they are inserted into respective conduits 26. The conduits 26 are then fitted over the outer diameters of the sockets 58. The optical fibers 18 are maintained as a single group and are routed through a specific socket 59 on the cover 44, wherein they are inserted as a group into the conduit 28 that is then fitted over the outer diameter of the socket 59. The cover 44 is then threaded onto the body 42 to provide an enclosed canister 20.

Referring now to FIGS. 4 and 5, the second breakout canister 22 includes a body 62 and a cover 64. The body 62 includes a hollow stem 66 at one end and a funnelled receptacle 68 at the opposite end. The body 62 also includes a circumferential groove 65 on its outer surface that can receive a band clamp for mounting. The receptacle 68 includes an internal groove 70. The cover 64 has a plate 76 with sockets 78 that extend from one side thereof. Conduits 30 fit over the sockets 78 and extend therefrom (FIG. 1).

As can be seen in FIG. 1, the optical fibers within the conduit 28 enter the body 62 through the stem 66. The subgroups of optical fibers 18 are broken out and inserted into furcation tubes (not shown). The fiber subgroups are routed into respective sockets 78 in the cover 64 (i.e., on a side opposite from the stem 66), after which respective conduits 30 are attached to the sockets 78. The cover 64 is then attached to the body 62 with a snap ring (not shown) that is inserted into the groove 70.

The two-stage breakout arrangement described above can eliminate the need for a breakout enclosure at which all power and optical fibers are broken out. The use of two breakout canisters reduces the width of the assembly (compared to that of a single enclosure) so that wind loads are significantly reduced. In some embodiments, the length of the conduit 28 is sufficient that the stem of the second breakout canister 24 “clears” the cover 44 of the first breakout canister 22 in the longitudinal direction (i.e., along the length of the conduit 28), such that the first and second breakout canisters 22, 24 can be mounted endwise on an antenna tower or similar structure. This length is typically between about 5 and 10 inches.

In addition, the assembly does not require the installer to connect all of the cables to panel mount adapters, then jumper cables to the adapters. Elimination of these steps can reduce the installation time.

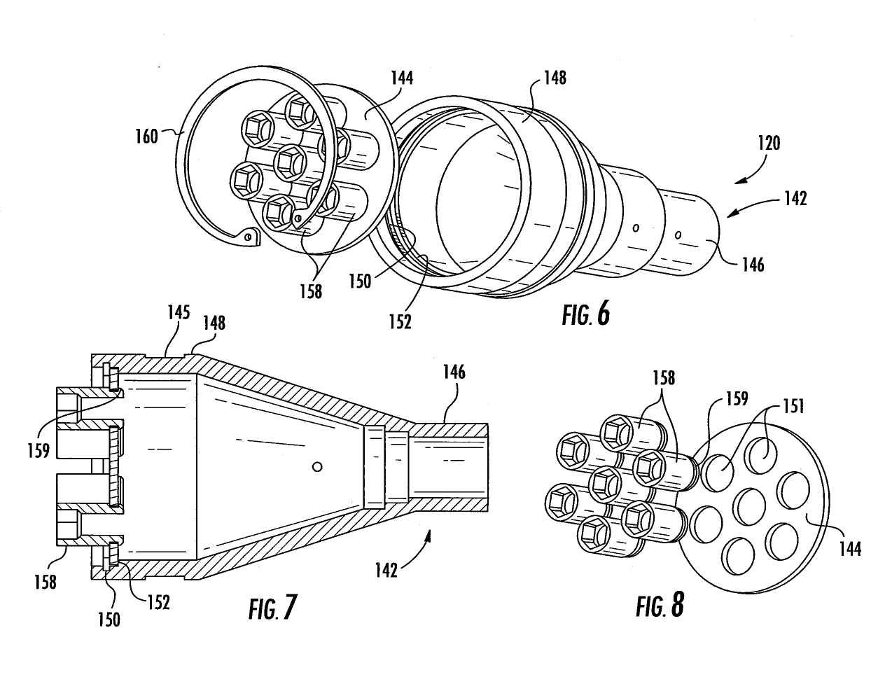

An alternative configuration for the first breakout canister shown in FIGS. 6-8 and designated broadly at 120. The first breakout canister 120 comprises a body 142, a flat cover 144, sockets 158 and a snap ring 160. The body 142 includes a hollow stem 146 at one end and a cylindrical receptacle 148 with an internal circumferential groove 150 at the opposite end. A shoulder 152 is present adjacent the groove 150. The body 142 also includes a circumferential groove 145 on its outer surface that can receive a band clamp for mounting. As can be seen in FIG. 8, the cover 144 includes apertures 151. Each of the sockets 158 has a retaining ridge 159 that enables it to remain in place when inserted into one of the apertures 151 of the cover 144, although in other embodiments the sockets 158 may be attached via other means, such as threads or C-clips.

The first breakout canister 120 can be assembled by inserting the sockets 158 into the apertures 151. The power cables and optical fibers are broken out, spliced and routed through the sockets 158 and conduits (not shown in FIGS. 6-8) as described above. The cover 144 is positioned in the body 142 so that the edge of the cover 144 abuts the shoulder 152. The snap ring 160 is then compressed radially and positioned against the cover 144. When the deflected snap ring 160 is released, it recovers toward its original shape and fits within the groove 150, thereby securing the cover 144 to the body 142.

The first breakout canister 120 may be desirable as a design that is relatively easy to manufacture (as no internal threads need to be formed on the cover 144) and to assemble.

Those skilled in this art will appreciate that, in some embodiments, the optical fibers may be broken out in the first canister and the power conductors may be broken out in the second canister. Also, either the first or second canister may be replaced with multiple canisters if such a design may be desirable for wind loading or the like.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An assembly, comprising:
a hybrid power/fiber optic cable comprising a plurality of power conductors and a plurality of optical fibers, the plurality of power conductors and the plurality of optical fibers contained within a common jacket;
a first breakout canister;
a second breakout canister;
wherein the hybrid power/fiber optic cable enters the first breakout canister and a plurality of power cords exit the first breakout canister, the power conductors of the hybrid power/fiber optic cable and the power cords being electrically connected within the first breakout canister, a respective one of a plurality of first conduits attached to the first breakout canister and protecting each of the plurality of power cords;
wherein the plurality of optical fibers enters the first breakout canister and exits the first breakout canister, the exiting plurality of optical fibers being protected by a second conduit attached to the first breakout canister; and
wherein the plurality of optical fibers enters the second breakout canister and exits the second breakout canister, the exiting plurality of optical fibers being divided into subgroups, each subgroup being protected by a respective one of a plurality of third conduits attached to the second breakout canister.

2. The assembly defined in claim 1, wherein any of the first, second and third conduits is at least 19 mm in diameter.

3. The assembly defined in claim 1, wherein the length of the second conduit is sufficient to enable the second breakout canister to longitudinally clear the first breakout canister.

4. The assembly defined in claim 1, wherein the hybrid power/fiber optic cable enters the first breakout canister on a first side thereof and a plurality of power cords exit the first breakout canister on a second side thereof, the plurality of optical fibers enters the first breakout canister on a first side and exits the first breakout canister on the second side, and the plurality of optical fibers enters the second breakout canister on a first side thereof and exits the second breakout canister on a second side thereof.

5. The assembly defined in claim 1, wherein each subgroup of optical fibers resides in a respective furcation tube.

6. The assembly defined in claim 1, wherein each of the first and second canisters includes a body and a cover.

7. The assembly defined in claim 6, wherein each of the covers of the first and second canisters is attached to its respective body via a snap ring.

8. An assembly, comprising:
a hybrid power/fiber optic cable comprising a plurality of power conductors and a plurality of optical fibers, the plurality of power conductors and the plurality of optical fibers contained within a common jacket;
a first breakout canister;
a second breakout canister;
wherein the hybrid power/fiber optic cable enters the first breakout canister and a plurality of power cords exit the first breakout canister, the power conductors of the hybrid power/fiber optic cable and the power cords being electrically connected within the first breakout canister, a respective one of a plurality of first conduits attached to the first breakout canister and protecting each of the plurality of power cords;
wherein the plurality of optical fibers enters the first breakout canister and exits the first breakout canister, the exiting plurality of optical fibers being protected by a second conduit attached to the first breakout canister; and
wherein the plurality of optical fibers enters the second breakout canister and exits the second breakout canister, the exiting plurality of optical fibers being divided into subgroups, each subgroup being protected by a respective one of a plurality of third conduits attached to the second breakout canister; and
wherein each of the first, second and third plurality of conduits is at least 19 mm in diameter.

9. The assembly defined in claim 8, wherein the length of the second conduit is sufficient to enable the second breakout canister to longitudinally clear the first breakout canister.

10. The assembly defined in claim 8, wherein the hybrid power/fiber optic cable enters the first breakout canister on a first side thereof and a plurality of power cords exit the first breakout canister on a second side thereof, the plurality of optical fibers enters the first breakout canister on a first side and exits the first breakout canister on the second side, and the plurality of optical fibers enters the second breakout canister on a first side thereof and exits the second breakout canister on a second side thereof.

11. The assembly defined in claim 8, wherein each subgroup of optical fibers resides in a respective furcation tube.

12. The assembly defined in claim 8, wherein each of the first and second canisters includes a body and a cover.

13. The assembly defined in claim 8, wherein each of the covers of the first and second canisters is attached to its respective body via a snap ring.

14. An assembly, comprising:
a hybrid power/fiber optic cable comprising a plurality of power conductors and a plurality of optical fibers, the plurality of power conductors and the plurality of optical fibers contained within a common jacket;
a first breakout canister;
a second breakout canister;
wherein the hybrid power/fiber optic cable enters the first breakout canister and a plurality of power cords exit the first breakout canister, the power conductors of the hybrid power/fiber optic cable and the power cords being electrically connected within the first breakout canister, a respective one of a plurality of first conduits attached to the first breakout canister and protecting each of the plurality of power cords;
wherein the plurality of optical fibers enters the first breakout canister and exits the first breakout canister, the exiting plurality of optical fibers being protected by a second conduit attached to the first breakout canister; and
wherein the plurality of optical fibers enters the second breakout canister and exits the second breakout canister, the exiting plurality of optical fibers being divided into subgroups, each subgroup being protected by a respective one of a plurality of third conduits attached to the second breakout canister; and
wherein the assembly is connected with a 9 remote radio head (RRU) configuration.

15. The assembly defined in claim 14, wherein each of the first, second and third plurality of conduits is at least 19 mm in diameter.

16. The assembly defined in claim 14, wherein the length of the second conduit is sufficient to enable the second breakout canister to longitudinally clear the first breakout canister.

17. The assembly defined in claim 14, wherein the hybrid power/fiber optic cable enters the first breakout canister on a first side thereof and a plurality of power cords exit the first breakout canister on a second side thereof, the plurality of optical fibers enters the first breakout canister on a first side and exits the first breakout canister on the second side, and the plurality of optical fibers enters the second breakout canister on a first side thereof and exits the second breakout canister on a second side thereof.

18. The assembly defined in claim 14, wherein each subgroup of optical fibers resides in a respective furcation tube.

19. The assembly defined in claim 14, wherein each of the first and second canisters includes a body and a cover.

20. The assembly defined in claim 14, wherein each of the covers of the first and second canisters is attached to its respective body via a snap ring.
